(19) United States
(12) Patent Application Publication
(10) Pub. No.: US 2025/0338041 A1
(43) Pub. Date: Oct. 30, 2025

(54) PHOTOELECTRIC CONVERSION APPARATUS AND EQUIPMENT

(71) Applicant: CANON KABUSHIKI KAISHA, Tokyo (JP)

(72) Inventors: KOICHIRO IWATA, Kanagawa (JP); KAZUHIRO SAITO, Tokyo (JP)

(21) Appl. No.: 19/180,359

(22) Filed: Apr. 16, 2025

(30) Foreign Application Priority Data
Apr. 26, 2024 (JP) 2024-072929

(51) Int. Cl. H04N 25/78

(52) U.S. Cl. CPC H04N 25/78

(57) ABSTRACT

A photoelectric conversion apparatus is provided. The apparatus includes a pixel array, A/D conversion circuits converting pixel signals output from the pixel array into digital signals, and signal lines to which reference signals with different gradients of changes are supplied. Each of the A/D conversion circuits includes a comparator comparing the pixel signal with the reference signal, a selector selecting a signal line, of the signal lines, to which a reference signal used for A/D conversion is supplied, and a connector connecting a signal line, of the signal lines, which is selected by the selector to the comparator via a buffer and connect a signal line, of the signal lines, which is not selected by the selector to a load capacitance element via another buffer different from the buffer.

### BACKGROUND OF THE INVENTION

### Field of the Invention

The present disclosure relates to a photoelectric conversion apparatus and equipment.

### Description of the Related Art

It is known that a photoelectric conversion apparatus performs A/D conversion by comparing a pixel signal output from a pixel with a reference signal that temporally changes by using a comparator. Japanese Patent Laid-Open No. 2013-179577 discloses that in a solid-state imaging apparatus to which a plurality of types of reference signals differing in the gradient of change are supplied, a reference signal used for A/D conversion is selected in accordance with the signal level of a pixel signal for each column for reading out signals. In selecting a reference signal for each column, the number of loads to be connected to each reference signal line changes for each A/D conversion, and variation in load may change the signal level of a reference signal and reduce the accuracy of A/D conversion. FIG. 16 in Japanese Patent Laid-Open No. 2013-179577 shows an arrangement in which a buffer is connected between each reference signal line and a comparator to suppress variation in the load connected to each reference signal line regardless of the use of any reference signal line.

### SUMMARY OF THE INVENTION

Some embodiments of the present disclosure provide a technique advantageous in further improving the accuracy of A/D conversion. According to some embodiments, a photoelectric conversion apparatus comprising a pixel array provided with a plurality of pixels, a plurality of A/D conversion circuits configured to convert pixel signals output from the pixel array into digital signals, and a plurality of reference signal lines to which reference signals with different gradients of changes are supplied, wherein each of the plurality of A/D conversion circuits includes a comparison circuit configured to compare the pixel signal with the reference signal, a selector configured to select a reference signal line, of the plurality of reference signal lines, to which a reference signal used for A/D conversion is supplied, and a connector configured to connect a reference signal line, of the plurality of reference signal lines, which is selected by the selector to the comparison circuit via a buffer and connect a reference signal line, of the plurality of reference signal lines, which is not selected by the selector to a load capacitance element via another buffer different from the buffer, is provided.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of a photoelectric conversion apparatus according to the present embodiment;

FIG. 2 is a circuit diagram showing an example of the arrangement of a pixel in the photoelectric conversion apparatus in FIG. 1;

FIG. 3 is a circuit diagram showing an example of the arrangement of an A/D conversion circuit in the photoelectric conversion apparatus in FIG. 1;

FIG. 4 is a timing chart showing an example of the operation of the photoelectric conversion apparatus in FIG. 1;

FIG. 5 is a circuit diagram showing an example of the arrangement of the A/D conversion circuit in the photoelectric conversion apparatus in FIG. 1;

FIG. 6 is a circuit diagram showing an example of the arrangement of the A/D conversion circuit in the photoelectric conversion apparatus in FIG. 1; and

FIG. 7 is a view showing an example of the arrangement of equipment incorporating the photoelectric conversion apparatus in FIG. 1.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

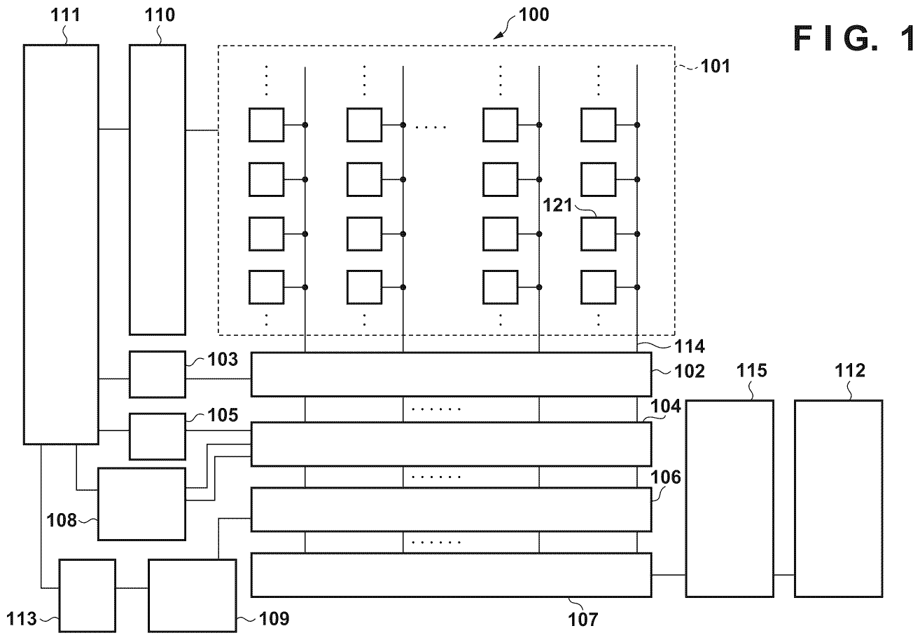

A photoelectric conversion apparatus according to an embodiment of the present disclosure will be described with reference to FIGS. 1 to 6. FIG. 1 is a block diagram showing an example of the arrangement of a photoelectric conversion apparatus 100. The photoelectric conversion apparatus 100 includes a pixel array 101, a vertical readout circuit 102, an analog/digital (A/D) conversion circuit 104, a column memory 106, a horizontal scanning circuit 107, a signal processing circuit 115, a signal output circuit 112, a vertical scanning circuit 110, and a timing generator 111. The photoelectric conversion apparatus 100 also includes a reference bias circuit 103, a reference bias circuit 105, a ramp signal generation circuit 108, a phase locked loop (PLL) circuit 113, and a counter 109.

The pixel array 101 has a plurality of pixels 121 arranged in a two-dimensional array pattern so as to form a plurality of rows and a plurality of columns. The vertical readout circuit 102 is provided to read out pixel signals from the pixel array 101. The reference bias circuit 103 can generate a reference bias for the vertical readout circuit 102 and can also generate a pulse signal for controlling the vertical readout circuit 102. The A/D conversion circuit 104 converts a pixel signal as an analog signal output from the pixel array 101 into a digital signal. FIG. 1 shows the A/D conversion circuit 104 as one block. The photoelectric conversion apparatus 100 is provided with a plurality of A/D conversion circuits 104 so as to respectively correspond to a plurality of vertical output lines 114 provided in accordance with, for example, the pixel rows of the pixel array 101. The A/D conversion circuit 104 will be described in detail later. The reference bias circuit 105 can generate a reference bias for the A/D conversion circuit 104 and can also generate a pulse signal for controlling the A/D conversion circuit 104. The ramp signal generation circuit 108 generates a reference signal (ramp signal) used for comparison with a pixel signal in the A/D conversion circuit 104. The ramp signal generation circuit 108 supplies a plurality of types of reference signals differing in the gradient of temporal change via a plurality of reference signal lines. The column memory 106 holds the value of the counter 109 in accordance with the conversion result obtained by the A/D conversion circuit 104. The PLL circuit 113 generates a reference clock used in the counter 109. The horizontal scanning circuit 107 transfers the digital value held in the column memory 106 to the signal processing circuit 115. The signal output circuit 112 is a circuit for outputting a signal processed by the signal processing circuit 115 from the photoelectric conversion apparatus 100 to the outside. The vertical scanning circuit 110 scans the pixel array 101 in the vertical direction. The vertical scanning circuit 110 scans the pixel array to output a pixel signal from the pixel 121. The timing generator 111 supplies control signals to the reference bias circuits 103 and 105, the ramp signal generation circuit 108, the counter 109, the vertical scanning circuit 110, and the PLL circuit 113 to control the operations of the respective components provided in the photoelectric conversion apparatus 100. In this case, the vertical readout circuit 102 includes a current source load for reading out a pixel signal from the pixel 121 or a column amplifier for a current source load and signal amplification. The present embodiment will exemplify the vertical readout circuit 102 as a current source load.

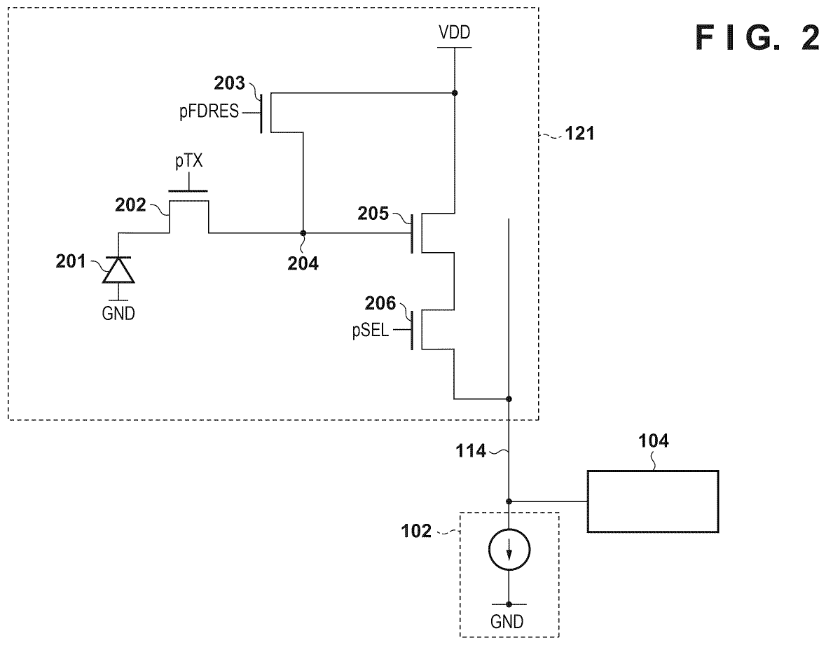

FIG. 2 is a circuit diagram showing an example of the arrangement of the pixel 121. FIG. 2 also shows the connection relationship between the pixel 121, the vertical readout circuit 102, and the A/D conversion circuit 104. The pixel 121 includes a photodiode 201, a transfer transistor 202, a reset transistor 203, an amplification transistor 205, and a selection transistor 206. The photodiode 201 generates electric charge corresponding to incident light. The transfer transistor 202 transfers the electric charge photoelectrically converted by the photodiode 201 to a floating fusion 204. The reset transistor 203 resets the floating fusion 204 to the potential of a power line VDD. The amplification transistor 205 is an amplification transistor that converts a signal from the floating fusion 204 into a voltage signal. The selection transistor 206 is arranged between the amplification transistor 205 and the vertical output line 114. When the selection transistor 206 is set in an ON (conductive) state, a pixel signal is output from the pixel 121 to a vertical scanning line 141.

A control signal pTX is supplied to the gate of the transfer transistor 202. If the control signal pTX is at high level (Hi), the transfer transistor 202 is turned on to transfer the electric charge photoelectrically converted by the photodiode 201 to the floating fusion 204. A control signal pFDRES is supplied to the gate of the reset transistor 203. If the control signal pFDRES is at high level, the reset transistor 203 is turned on to establish continuity between the floating fusion 204 and the power line VDD and reset the floating fusion 204 to the potential of the power line VDD. A control signal pSEL is supplied to the gate of the selection transistor 206. If the control signal pSEL is at high level, the selection transistor is turned on to electrically connect the source of the amplification transistor 205 to the vertical output line 114.

The vertical readout circuit 102 and the A/D conversion circuit 104 are connected to the vertical output line 114. In the present embodiment, the vertical readout circuit 102 is a current source load as described above.

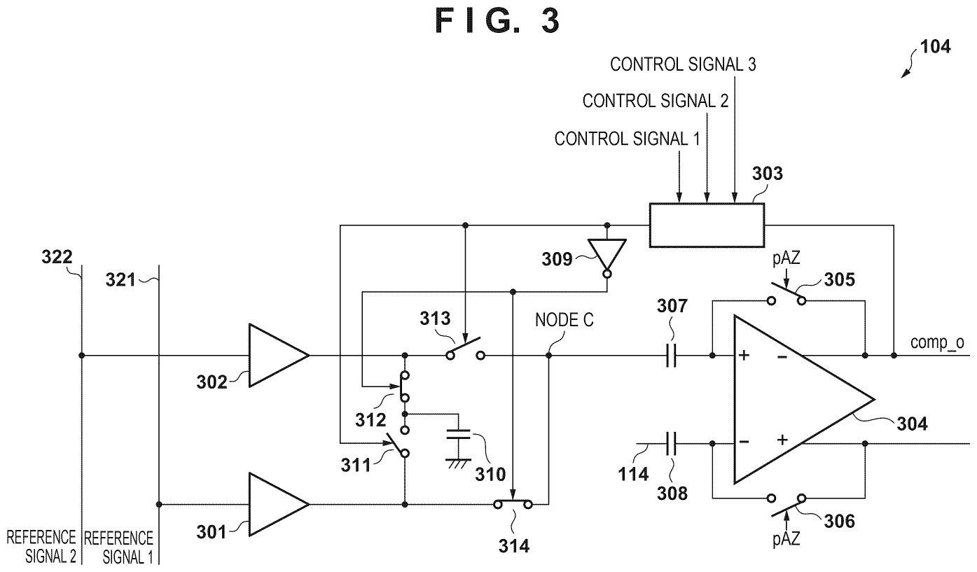

FIG. 3 is a circuit diagram showing an example of the arrangement of the A/D conversion circuit 104 according to the present embodiment. As described above, although the photoelectric conversion apparatus 100 is provided with a plurality of A/D conversion circuits 104, FIG. 3 shows the circuit arrangement of one A/D conversion circuit 104. The A/D conversion circuit 104 can include a comparison circuit 304, a selector 303, buffers 301 and 302, and a connector. The comparison circuit 304 compares a pixel signal supplied from the pixel array 101 with a reference signal supplied from the ramp signal generation circuit 108. The selector 303 selects a reference signal line, of a plurality of reference signal lines 321 and 322 connected to the ramp signal generation circuit 108, to which a reference signal used for A/D conversion is supplied. The connector connects the reference signal line, of the reference signal lines 321 and 322, which is selected by the selector 303 to the comparison circuit 304 via one of the buffers 301 and 302. The connector connects the reference signal line, of the reference signal lines 321 and 322, which is not selected by the selector 303 as a reference signal line used for A/D conversion to a load capacitance element 310 via the other of the buffers 301 and 302. The arrangement shown in FIG. 3 is provided with the two reference signal lines 321 and 322, to which two types of reference signals differing in the gradient of temporal change are supplied. In addition, this arrangement is provided with the two buffers 301 and 302. However, limitation is not made thereto. The arrangement may be provided with three or more reference signal lines, to which three or more types of reference signals differing in the gradient of temporal change are supplied, and three or more buffers in accordance with the number of reference signal lines arranged. The number of reference signal lines that supply reference signals can be equal to the number of buffers provided in one A/D conversion circuit 104.

In the arrangement shown in FIG. 3, the plurality of reference signal lines 321 and 322 are respectively connected to the input nodes of the plurality of buffers 301 and 302 such that one reference signal line corresponds to one buffer. More specifically, the input node of the buffer 301 is connected to the reference signal line 321, and the input node of the buffer 302 is connected to the reference signal line 322. The ramp signal generation circuit 108 respectively supplies reference signal 1 and reference signal 2 differing in the gradient of change to the reference signal lines 321 and 322.

The output node of the buffer 301 is connected to one of the two terminals of each of a switch 311 and a switch 314. The output node of the buffer 302 is connected to one of the two terminals of each of a switch 312 and a switch 313. One of the two terminals of the switch 311 which is not connected to the buffer 301 and one of the two terminals of the switch 312 which is not connected to the buffer 302 are connected to the load capacitance element 310. As shown in FIG. 3, the load capacitance element 310 can be a grounded capacitance element having one terminal connected to the ground level. One of the two terminals of the switch 314 which is not connected to the buffer 301 and one of the two terminals of the switch 313 which is not connected to the buffer 302 are connected to a clamp capacitance element 307 connected to a positive input terminal that is one of the input nodes of the comparison circuit 304.

A switch 305 is provided between the positive input terminal and the negative output terminal of the comparison circuit 304. The vertical output line 114 is connected to the negative input terminal of the comparison circuit 304 via a clamp capacitance element 308. A switch 306 is provided between the negative input terminal and the positive output terminal of the comparison circuit 304. The negative output terminal of the comparison circuit 304 is connected to the selector 303 and the column memory 106.

The selector 303 also functions as a determination circuit that determines the signal level of a supplied pixel signal and selects one of the plurality of reference signal lines 321 and 322 to which a reference signal used for A/D conversion is supplied in accordance with the determination result. If an output from the selector 303 is at low level (Lo), the switches 311 and 313 are set in an OFF (nonconductive) state. In addition, an output from an inverter 309 is at high level, and the switches 312 and 314 are set in the ON state. If an output from the selector 303 is at high level, the switches 311 and 313 are set in the ON state. In addition, an output from the inverter 309 is at low level, and the switches 312 and 314 are set in the OFF state. That is, as described above, the selector 303 functions as a circuit that selects one of the reference signal lines 321 and 322 to which a reference signal used for A/D conversion is supplied. In addition, the switches 311 to 314 function as the above connectors that connect the reference signal lines 321 and 322 to the comparison circuit 304 or the load capacitance element 310 via the buffers 301 and 302. The switches 311 to 314 are configured to switch connection between the output nodes of the buffers 301 and 302 and the input nodes of the comparison circuit 304 and the load capacitance element 310.

Control signals 1 to 3 are supplied to the selector 303. Control signals 1 to 3 may be supplied from the timing generator 111 or supplied from a selector control circuit that operates in accordance with control signals supplied from the timing generator 111. Control signal 1 is a reset signal for the selector 303. If, for example, a high-level signal is supplied, the selector 303 is reset. Control signal 2 is an input enable signal for the selector 303. If the input enable signal is at high level, the selector 303 accepts an input signal. Control signal 3 is an output enable signal for the selector 303. If the output enable signal is at high level, the above determination result obtained by the selector 303 is output.

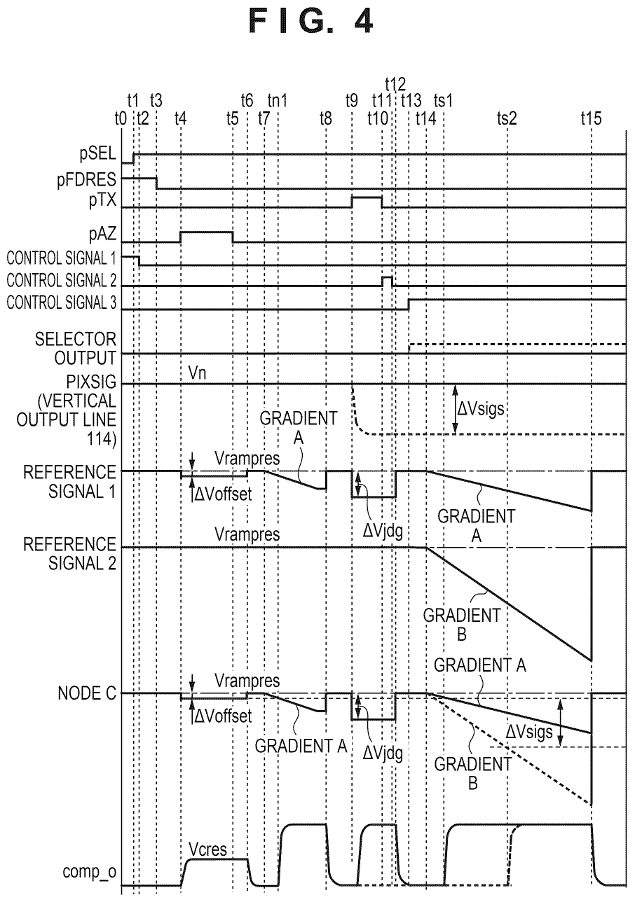

The operations of the pixel 121 and the A/D conversion circuit 104 will be described next with reference to FIG. 4. At time t1, the control signal pSEL is set at high level, and the selection transistor 206 transitions to the ON state. As a result, the source of the amplification transistor 205 is connected to the vertical output line 114. In the interval from time t0 to time t3, the control signal pFDRES is set at high level, the reset transistor 203 is set in the ON state, and the floating fusion 204 is reset at the potential of the power line VDD.

Assume that a potential PIXSIG of the vertical output line 114 when the floating fusion 204 is reset is a potential Vn. When, for example, the reset transistor 203 transitions to the OFF state, the potential of the floating fusion 204 varies. This variation also appears as a potential variation at the potential PIXSIG. However, for the sake of simplification, this specification makes no reference to potential variation caused when the reset transistor 203 changes between the ON state and the OFF state.

In the interval from time t0 to time t2, control signal 1 supplied to the selector 303 is set at high level to reset the state of the selector 303. An output from the reset selector 303 is set at low level. Since control signal 3 is kept at low level until time t13, the selector 303 keeps outputting low level until time t13. Accordingly, in the interval from time t0 to time t13, the switches 311 and 313 are set in the OFF (nonconductive) state, and the switches 312 and 314 are set in the ON state. For this reason, the buffer 301 connected to the reference signal line 321 is connected to the comparison circuit 304 via the clamp capacitance element 307, and the buffer 302 connected to the reference signal line 322 is connected to the load capacitance element 310. That is, the potential of a node C between the buffers 301 and 302 and the clamp capacitance element 307 (the comparison circuit 304) is the potential of the reference signal line 321 until time t13.

A potential Vrampres that is the initial potential of the ramp signal generation circuit 108 in the interval from time t0 to time t4 is supplied to the reference signal line 321. In addition, the potential Vrampres is supplied from the ramp signal generation circuit 108 to the reference signal line 322 in the interval from time t0 to time t14.

In the interval from time t4 to time t5, a control signal pAZ is set at high level. The control signal pAZ is a signal that controls the switches 305 and 306. In the period in which the control signal pAZ is at high level, the switches 305 and 306 are in the ON state. In the interval from time t4 to time t6, a potential decreased from the potential Vrampres by ΔVoffset is supplied to the reference signal line 321.

In a period in which the control signal pAZ is at high level, the reference signal line 321 is connected to the clamp capacitance element 307 via the buffer 301, and the vertical output line 114 is connected to the clamp capacitance element 308. The potentials at this time are respectively written in the clamp capacitance element 307 and the clamp capacitance element 308. At time t5, the control signal pAZ is set at low level, and the switches 305 and 306 transition to the OFF state, thus terminating the clamping operation.

With this clamping operation, the potentials of the positive input terminal and the negative input terminal of the comparison circuit 304 become the same, and an output comp_o of the comparison circuit 304 is equal to that of each input terminal. The potential at this time changes depending on the circuit arrangement. In the following description, this potential is assumed to be a potential Vcres.

At time t6, the potential of the reference signal line 321 returns to the potential Vrampres. At this time, a potential Vinp of the positive input terminal and a potential Vinn of the negative input terminal of the comparison circuit 304 have a relation defined by Vinp>Vinn, and hence the output comp_o of the comparison circuit 304 is set at low level. At time t7, reference signal 1 is supplied to the reference signal line 321, and the potential of the reference signal line 321 decreases from the potential Vrampres at a gradient A.

If the potential of the node C decreases from the potential Vrampres by about ΔVoffset in conjunction with a change in the potential of the reference signal line 321, the potential Vinp of the positive input terminal and the potential Vinn of the negative input terminal of the comparison circuit 304 have a relation defined by Vinp<Vinn. As a result, the output comp_o of the comparison circuit 304 transitions to high level. This transition occurs near time tn1 shown in FIG. 3, and the potential Vn of the vertical output line 114 at time tn1 undergoes A/D conversion.

At time t8, the potential of the reference signal line 321 returns to the potential Vrampres. With this operation, since the potential Vinp of the positive input terminal and the potential Vinn of the negative input terminal of the comparison circuit 304 have a relation defined by Vinp>Vinn, the output comp_o of the comparison circuit 304 is set at low level.

At time t9, the control signal pTX is set at high level, and the electric charge photoelectrically converted by the photodiode 201 is transferred to the floating fusion 204. If no light enters the photodiode 201 and no electric charge is stored in the photodiode 201 (at dark time), no electric charge is transferred to the floating fusion 204, and the potential PIXSIG is maintained at the potential Vn as indicated by the solid line. In practice, a dark current component and the potential of the floating fusion 204 at the time of the operation of the transfer transistor 202 vary. However, no consideration is given to such variation in this case. In contrast to this, if electric charge is stored in the photodiode 201 and transferred to the floating fusion 204, the potential PIXSIG changes as indicated by the broken line. Assume that a voltage change on the vertical output line 114 due to this stored electric charge is denoted by ΔVsigs.

At time t10, the control signal pTX is set at low level to set the transfer transistor 202 in the OFF state. This completes the transfer of electric charge from the photodiode 201 to the floating fusion 204.

In the interval from time t9 to time t12, the potential of the reference signal line 321 decreases from the potential Vrampres by ΔVjdg. The voltage ΔVjdg is a comparative voltage for determining the signal level of the potential PIXSIG. The selector 303 determines whether ΔVsig is larger or smaller than (ΔVjdg−ΔVoffset). This determining operation will be described next.

At dark time, at time t9, the change amount of the potential Vinn of the negative input terminal of the comparison circuit 304 is 0 V, and the change amount of the potential Vinp of the positive input terminal is −(ΔVjdg−ΔVoffset) at the end of the clamping operation. Accordingly, Vinp<Vinn, and the output comp_o from the comparison circuit 304 transitions to high level and is input to the selector 303.

In contrast, the photodiode operates as follows if the potential PIXSIG changes by ΔVsigs upon irradiation with light. In contrast to the state at the time of end of a clamping operation, the change amount of the potential Vinn of the negative input terminal of the comparison circuit 304 is −ΔVsigs, and the change amount of the potential Vinp of the positive input terminal is −(ΔVjdg−ΔVoffset). In the case of ΔVsigs<(ΔVjdg−ΔVoffset), since Vinp<Vinn, the output comp_o from the comparison circuit 304 is set at high level and input to the selector 303 as in the case of dark time. In the case of ΔVsigs>(ΔVjdg−ΔVoffset), since Vinp>Vin, the output comp_o from the comparison circuit 304 is set at low level and input to the selector 303.

In the interval from time t10 to time t11, control signal 2 that controls the selector 303 is set at high level. The selector 303 holds a determination result in accordance with the level of the output comp_o from the comparison circuit 304 which is input to the selector 303 in a period in which control signal 2 is at high level. The following are the determination results. If the output comp_o from the comparison circuit 304 is at high level (a pixel signal is smaller than a determination signal), the selector 303 outputs low level. If the output comp_o from the comparison circuit 304 is at low level (a pixel signal is larger than a determination signal), the selector 303 outputs high level.

The potential of the reference signal line 321 at time t12 returns to the potential Vrampres. This also sets the output comp_o from the comparison circuit 304 at low level.

At time t13, control signal 3 that controls the selector 303 is set at high level to enable the selector 303 to output the held determination result. As described above, in the case of ΔVsigs<(ΔVjdg−ΔVoffset), the selector 303 outputs low level. With this operation, the switches 312 and 314 are set in the ON state, and the switches 311 and 313 are set in the OFF state to connect the output node of the buffer 301 connected to the reference signal line 321 to the node C. In addition, the output node of the buffer 302 connected to the reference signal line 322 is connected to the load capacitance element 310. In contrast, in the case of ΔVsigs>(ΔVjdg−ΔVoffset), the selector 303 outputs high level. With this operation, the switches 312 and 314 are set in the OFF state, and the switches 311 and 313 are set in the ON state to connect the output node of the buffer 302 connected to the reference signal line 322 to the node C. In addition, the output node of the buffer 301 connected to the reference signal line 321 is connected to the load capacitance element 310. The interval from time t9 to time 13 is sometimes referred to as a signal level determination period.

At time t14, reference signal 1 is supplied to the reference signal line 321, and the potential of the reference signal line 321 decreases from the potential Vrampres at the gradient A. In addition, reference signal 2 is supplied to the reference signal line 322, and the potential of the reference signal line 322 decreases from the potential Vrampres at a gradient B. In this case, since gradient A<gradient B, reference signal 1 is higher in gain than reference signal 2. If it is determined that the signal level of the potential PIXSIG is smaller than (ΔVjdg−ΔVoffset), A/D conversion is performed by using reference signal 1 with a high gain and the gradient A. If it is determined that the signal level of the potential PIXSIG is larger than (ΔVjdg−ΔVoffset), A/D conversion is performed by using reference signal 2 with a low gain and the gradient B.

Since A/D conversion is performed by using reference signal 1 at dark time, the potential of the node C transitions at the gradient A as indicated by the solid line. At time ts1, the potential Vinp of the positive input terminal and the potential Vinn of the negative input terminal of the comparison circuit 304 have a relation of Vinp<Vinn, and the output comp_o from the comparison circuit 304 transitions to high level. This completes the A/D conversion of the pixel signal output from the photodiode 201 at dark time.

In contrast, if the potential PIXSIG changes by ΔVsigs upon photoelectric conversion to result in ΔVsigs>(ΔVjdg−ΔVoffset), A/D conversion is performed by using reference signal 2. Accordingly, the potential of the node C transitions at the gradient B indicated by the broken line. At time ts2, the potential of the node C is set to (Vrampres−ΔVoffset−ΔVsigs). As a result, the potential Vinp of the positive input terminal and the potential Vinn of the negative input terminal of the comparison circuit 304 have a relation of Vinp<Vinn. Consequently, the output comp_o from the comparison circuit 304 transitions to high level, and A/D conversion of ΔVsigs is completed.

At time t15, both reference signal 1 and reference signal 2 are set at the potential Vrampres. Accordingly, the output comp_o from the comparison circuit 304 transitions to low level. The interval from time t14 to time t15 is sometimes referred to as an S conversion period.

In the present embodiment, the reference signal used in an S conversion period is switched depending on the result obtained in a signal level determination period. This means that the use ratio between reference signal 1 and reference signal 2 in an S conversion period changes depending on the luminance of light entering the photodiode. For example, if the buffers 301 and 302 are circuits including source follower circuits, such as source follower amplifiers, loads connected to the output sides of the buffers 301 and 302 may influence the input sides. For this reason, if the loads connected to the output nodes of the buffers 301 and 302 do not match between the buffers 301 and 302, the loads connected to the reference signal lines 321 and 322 change every time the use ratio between reference signal 1 and reference signal 2 changes. Consequently, in an S conversion period, the gradients A and B of reference voltages 1 and 2 may vary depending on the luminance. As a result, a deterioration in linearity of A/D conversion and the occurrence of smear may degrade the image quality of an obtained image.

In contrast to this, in the A/D conversion circuit 104 according to the present embodiment, the output node of the buffer 301 or 302 connected to the reference signal line 321 or 322 which is not used for A/D conversion is connected to the load capacitance element 310. If, for example, reference signal 1 flowing through the reference signal line 321 is used for A/D conversion, the buffer 302 connected to the reference signal line 322 different from the buffer 301 connected to the reference signal line 321 is connected to the load capacitance element 310. This suppresses a change in the load connected to each of the reference signal lines 321 and 322 regardless of a change in the ratio between reference signals 1 and 2 used for A/D conversion.

The capacitance value of the load capacitance element 310 is set in consideration of a parasitic capacitance at the time of layout of the photoelectric conversion apparatus 100, the input capacitance of the positive input terminal of the comparison circuit 304, and the like. The capacitance value of the load capacitance element 310 is in the order of, for example, several 100 fF, although it depends on the circuit constant and the layout. The load capacitance element 310 may be formed by using a Metal-Insulator-Metal (MIM) structure or may be formed as a MOS capacitor. Alternatively, the load capacitance element 310 may be a capacitor having a PIP structure in which an insulating layer is sandwiched between a plurality of polysilicon layers. In this case, likewise, all the remaining capacitance elements written in this specification and drawings may be implemented by capacitors having a MIM structure, MOS capacitors, or capacitors having a PIP structure. Assume that in this specification, capacitances provided as structures are written as capacitance elements. In contrast to this, parasitic capacitances accompanying wiring, transistors, and the like are written as parasitic capacitances without the term “element”.

Providing the A/D conversion circuit 104 with the above structure can prevent loads connected to the output nodes of the buffers 301 and 302 from changing as much as possible. This makes it possible to accurately perform A/D conversion, such as suppressing a deterioration in linearity and the occurrence of smear. This results in suppressing a deterioration in the image quality of an image obtained by using the photoelectric conversion apparatus 100.

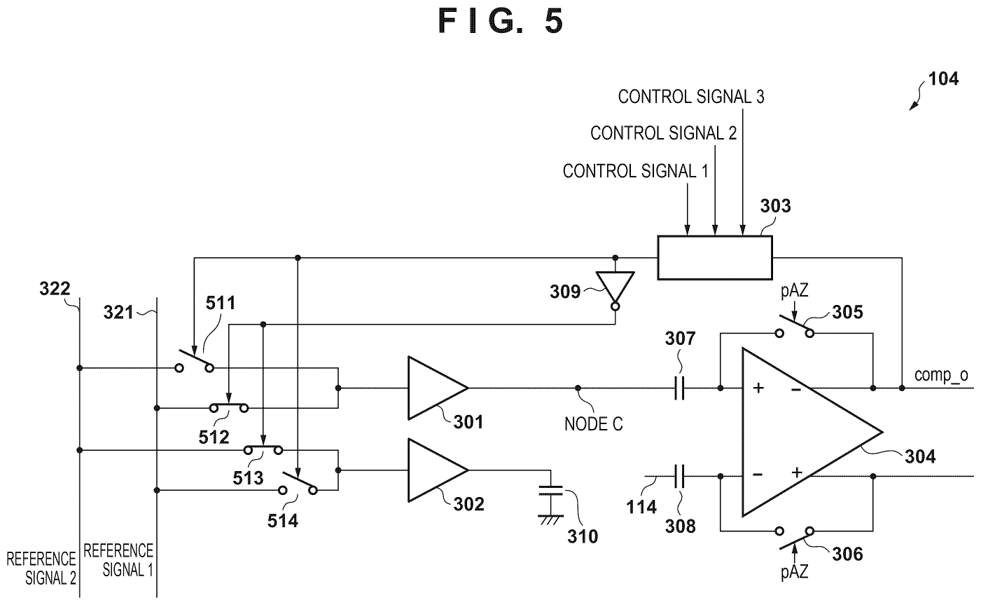

FIG. 5 is a circuit diagram showing a modification of the A/D conversion circuit 104 described above. In the A/D conversion circuit 104 shown in FIG. 3, the connection relationship between the reference signal lines 321 and 322 and the buffers 301 and 302 is fixed. In addition, the switches 311 to 314 functioning as connectors are configured to switch the connection between the output nodes of the buffers 301 and 302 and the input nodes of the comparison circuit 304 and the load capacitance element 310. In contrast to this, in the arrangement shown in FIG. 5, the output node of the buffer 301 is connected to the input node of the comparison circuit 304 via the clamp capacitance element 307, and the output node of the buffer 302 is connected to the output node of the load capacitance element 310. That is, the connection relationship between the output nodes of the buffers 301 and 302 and the input nodes of the comparison circuit 304 and the load capacitance element 310 is fixed. In contrast to this, switches 511 to 514 functioning as connectors are configured to switch the connection between the plurality of reference signal lines 321 and 322 and the input nodes of the buffers 301 and 302.

The switch 511 is arranged between the reference signal line 322 and the buffer 301. The switch 512 is arranged between the reference signal line 321 and the buffer 301. The output node of the buffer 301 is connected to the positive input terminal side that is the input node of the comparison circuit 304 via the clamp capacitance element 307. The switch 513 is arranged between the reference signal line 322 and the buffer 302. The switch 514 is arranged between the reference signal line 321 and the buffer 302. The output node of the buffer 302 is connected to the load capacitance element 310. As in the switches 311 to 314, the switches 511 to 514 are set in the following connection states in accordance with the determination results obtained by the selector 303.

In a signal level determination period, if the output comp_o from the comparison circuit 304 is at high level (the pixel signal is smaller than the determination level), the selector 303 outputs low level from time t13. With this operation, the switches 512 and 513 are set in the ON state, and the switches 511 and 514 are set in the OFF state. As a result, the reference signal line 321 is connected to the buffer 301, and the potential of the reference signal line 321 is supplied to the node C via the buffer 301. The reference signal line 322 is connected to the load capacitance element 310 via the buffer 302.

In contrast, in a signal level determination period, if the output comp_o from the comparison circuit 304 is at low level (the pixel signal is larger than the determination level), the selector 303 outputs high level from time t13. With this operation, the switches 511 and 514 are set in the ON state, and the switches 512 and 513 are set in the OFF state. As a result, the reference signal line 322 is connected to the buffer 301, and the potential of the reference signal line 322 is supplied to the node C via the buffer 301. In addition, the reference signal line 321 is connected to the load capacitance element 310 via the buffer 302.

With this operation, in the A/D conversion circuit 104 shown in FIG. 5, as in the above embodiment, in an S conversion period, the reference signal line 321 or 322 which is not used for A/D conversion is connected to the load capacitance element 310 via the buffer 302. This suppresses a change in the load connected to each of the reference signal lines 321 and 322 regardless of a change in the ratio between reference signals 1 and 2 used for A/D conversion. That is, the arrangement shown in FIG. 5 can accurately perform A/D conversion, such as suppressing a deterioration in linearity and the occurrence of smear. This results in suppressing a deterioration in the image quality of an image obtained by using the photoelectric conversion apparatus 100.

In the arrangement shown in FIG. 5, both reference signal 1 and reference signal 2 are supplied to the comparison circuit 304 via the same buffer regardless of which one of the signals is used. For example, in consideration of the case where A/D conversion is performed with a high gain, the arrangement shown in FIG. 5 can be regarded as being more suitable than the arrangement shown in FIG. 3.

In the interval from time t4 to time t5, (Vrampres−ΔVoffset) is clamped in the clamp capacitance element 307. Consider a case where a reference signal to be used is changed, and reference signals are supplied from different buffers based on the result obtained in a signal level determination period. In this case, A/D conversion may be started from the potential (Vrampres+Vbofst) at which the potential of the node C shifts from the potential Vrampres by a potential Vbofst due to the influence of the offset potential Vbofst of the buffer. In this case, the timing when the comparison circuit 304 is reversed at the time of A/D conversion in an S conversion period is slowed in the case where the potential Vbofst is added, whereas quickened in the case where the potential Vbofst is subtracted. As a result, the value obtained by A/D conversion includes an error. As a high gain is applied with a reference signal having a small gradient, the influence of the potential Vbofst increases. Accordingly, the arrangement shown in FIG. 5 in which the buffer connected to the comparison circuit 304 is fixed to the buffer 301 can perform A/D conversion with higher accuracy than the arrangement shown in FIG. 3.

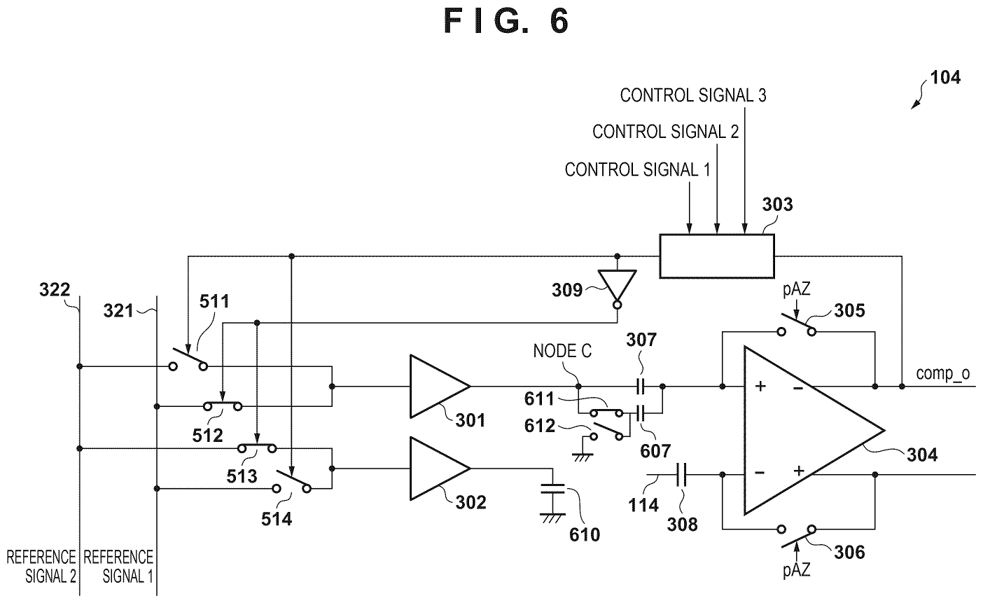

FIG. 6 is a circuit diagram showing a modification of the A/D conversion circuit 104 shown in FIG. 5. The arrangement shown in FIG. 6 differs from the arrangement shown in FIG. 5 in the arrangement of the clamp capacitance element between the buffer 301 and the positive input terminal as the input node of the comparison circuit 304 and the arrangement of the load capacitance element connected to the buffer 302. Other arrangements may be similar to the arrangement shown in FIG. 5, and hence each arrangement will be described with focus on different portions.

In the arrangement shown in FIG. 6, a load capacitance element 610 connected to the output node of the buffer 302 varies in capacitance value. The load capacitance element 610 can also be called a variable capacitance element. In addition to the clamp capacitance element 307, this arrangement is provided with a clamp capacitance element 607. One of the two terminals of the clamp capacitance element 607 is connected to the positive input terminal of the comparison circuit 304. The other of the two terminals of the clamp capacitance element 607 is connected to the buffer 301 via a switch 611 and is also connected to the ground level via a switch 612. The ground level may be equal to the potential level of a power line GND connected to the power supply of the vertical readout circuit 102 shown in FIG. 2.

The switches 611 and 612 are exclusively controlled such that the switch 612 is set in the OFF state if the switch 611 is set in the ON state, and the switch 612 is set in the ON state if the switch 611 is set in the OFF state. That is, if the switch 611 is set in the ON state and the switch 612 is set in the OFF state, the clamp capacitance element 307 and the clamp capacitance element 607 are connected in parallel between the positive input terminal of the comparison circuit 304 and the buffer 301. If the switch 611 is set in the OFF state and the switch 612 is set in the ON state, the clamp capacitance element 607 is connected to the ground level.

Consider a case where the clamp capacitance element 307 and the clamp capacitance element 607 have the same capacitance value. In contrast to the case where the switch 611 is set in the ON state, and the switch 612 is set in the OFF state, in the case where the switch 611 is set in the OFF state, and the switch 612 is set in the ON state, it is possible to reduce the gradient of a reference signal input to the positive input terminal of the comparison circuit 304 to about ½ with respect to the input of the same reference signal. That is, it is possible to increase the gain. In this case, the case where the switch 611 is set in the ON state, and the switch 612 is set in the OFF state will be referred to as a gain 1X mode, and the case where the switch 611 is set in the OFF state, and the switch 612 is set in the ON state will be referred to as a gain 2X mode.

Letting Cp be the capacitance value of a parasitic capacitance parasitic to the output node of the buffer 301, C1 be the capacitance value of each of the clamp capacitance elements 307 and 607, and Cin be the capacitance value of the input capacitance of the comparison circuit 304, the capacitance value connected to the output node of the buffer 301 in the gain 1X mode is expressed by

$$( 2 C 1 \times Cin ) / ( 2 C 1 + Cin ) + Cp \qquad ( 1 )$$

In contrast to this, in the gain 2X mode, the capacitance value connected to the output node of the buffer 301 is expressed by

$$( C {1}^{2} + C 1 \times Cin ) / ( 2 C 1 + Cin ) + Cp \qquad ( 2 )$$

Accordingly, the load to be connected to the output node of the buffer 301 changes depending on the gain mode. For this reason, in the arrangement shown in FIG. 6, the capacitance value of the load capacitance element 610 is made variable, and the capacitance value of the load capacitance element 610 is changed in accordance with the gain mode in consideration of a change in the gain mode of the load connected to the buffer 301. This makes it possible to reduce the deterioration in linearity and the occurrence of smear even when the gain is changed by using the clamp capacitance element 307 and the clamp capacitance element 607.

The capacitance value of the load capacitance element 610 may be set to correct variation in consideration of load variation caused by the manufacturing variation of the photoelectric conversion apparatus 100. The arrangement shown in FIGS. 3 and 5 may use the load capacitance element 610 with a variable capacitance value instead of the load capacitance element 310.

The arrangement shown in FIG. 6 can also accurately perform A/D conversion and suppress a deterioration in the image quality of an image obtained by using the photoelectric conversion apparatus 100. In addition, the arrangement shown in FIG. 6 is provided with the clamp capacitance elements 307 and 607 as clamp capacitance elements to be used and is configured to be able to set two capacitance values as clamp capacitance elements to be connected to the input node (positive input terminal) of the comparison circuit 304. This makes it possible to change the gain used for A/D conversion more than the arrangement shown in FIG. 3 or 5. According to the above description, the capacitance value of the clamp capacitance element 307 is set to be equal to that of the clamp capacitance element 607. However, limitation is not made thereto. The clamp capacitance elements 307 and 607 may have different capacitance values in accordance with the specifications required for the photoelectric conversion apparatus 100 (the A/D conversion circuit 104). In addition, this arrangement may be provided with another clamp capacitance element and the like and configured to be able to select one of three or more capacitance values of the clamp capacitance elements.

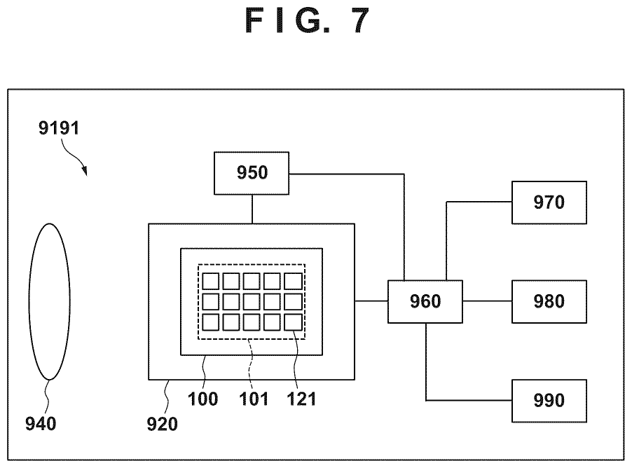

An application example of the photoelectric conversion apparatus 100 according to the present embodiment will be described below with reference to FIG. 7. FIG. 7 is a schematic view of equipment 9191 including the photoelectric conversion apparatus 100. As shown in FIG. 7, the photoelectric conversion apparatus 100 is housed in a package 920. The package 920 can include a base to which the photoelectric conversion apparatus 100 is fixed and a lid member made of glass or the like which faces the photoelectric conversion apparatus 100. In addition, the package 920 can include joining members such as bonding wires and bumps that connect the terminals provided on the base to the pads provided on the photoelectric conversion apparatus 100.

The equipment 9191 can include at least one of an optical device 940, a control device 950, a processing device 960, a display device 970, a storage device 980, and a mechanical device 990. The optical device 940 is implemented by, for example, a lens, a shutter, and a mirror. The control device 950 controls the photoelectric conversion device 100. The control device 950 is, for example, a semiconductor device such as an ASIC.

The processing device 960 processes a signal output from the photoelectric conversion device 100. The processing device 960 is a semiconductor device such as a CPU or an ASIC for forming an analog front end (AFE) or a digital front end (DFE). The display device 970 is an EL display device or a liquid crystal display device that displays information (image) obtained by the photoelectric conversion device 100. The storage device 980 is a magnetic device or a semiconductor device that stores the information (image) obtained by the photoelectric conversion device 100. The storage device 980 is a volatile memory such as an SRAM or a DRAM, or a nonvolatile memory such as a flash memory or a hard disk drive.

The mechanical device 990 includes a moving or propulsion unit such as a motor or an engine. In the equipment 9191, the signal output from the photoelectric conversion device 100 is displayed on the display device 970 or transmitted to an external device by a communication device (not shown) included in the equipment 9191. Hence, the equipment 9191 may further include the storage device 980 and the processing device 960 in addition to the memory circuits and arithmetic circuits included in the photoelectric conversion device 100. The mechanical device 990 may be controlled based on the signal output from the photoelectric conversion device 100.

In addition, the equipment 9191 is suitable for electronic equipment such as an information terminal (for example, a smartphone or a wearable terminal) which has a shooting function or a camera (for example, an interchangeable lens camera, a compact camera, a video camera, or a monitoring camera). The mechanical device 990 in the camera can drive the components of the optical device 940 in order to perform zooming, an in-focus operation, and a shutter operation. Alternatively, the mechanical device 990 in the camera can move the photoelectric conversion device 100 in order to perform an anti-vibration operation.

Furthermore, the equipment 9191 can also be applied to an onboard camera mounted in transportation equipment such as a vehicle, a ship, an airplane, or an industrial robot. The mechanical device 990 in the transportation equipment can be used as a moving device. The equipment 9191 as the transportation equipment is suitable for a device that transports the photoelectric conversion device 100 or a device that uses an image capturing function to assist and/or automate driving (steering). The processing device 960 for assisting and/or automating driving (steering) can perform, based on the information obtained by the photoelectric conversion device 100, processing for operating the mechanical device 990 as a moving device. The equipment 9191 incorporating the photoelectric conversion device 100 can be widely applied to equipment using object recognition such as an intelligent transport system (ITS), in addition to the transportation equipment. Alternatively, the equipment 9191 may be medical equipment such as an endoscope, measurement equipment such as a distance measurement sensor, analysis equipment such as an electron microscope, or office equipment such as a copy machine.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-072929, filed Apr. 26, 2024, which is hereby incorporated by reference herein in its entirety.

1. A photoelectric conversion apparatus comprising a pixel array provided with a plurality of pixels, a plurality of A/D conversion circuits configured to convert pixel signals output from the pixel array into digital signals, and a plurality of reference signal lines to which reference signals with different gradients of changes are supplied,
wherein each of the plurality of A/D conversion circuits includes a comparison circuit configured to compare the pixel signal with the reference signal, a selector configured to select a reference signal line, of the plurality of reference signal lines, to which a reference signal used for A/D conversion is supplied, and a connector configured to connect a reference signal line, of the plurality of reference signal lines, which is selected by the selector to the comparison circuit via a buffer and connect a reference signal line, of the plurality of reference signal lines, which is not selected by the selector to a load capacitance element via another buffer different from the buffer.

2. The apparatus according to claim 1, wherein the buffer and the other buffer include source follower circuits.

3. The apparatus according to claim 1, wherein the capacitance value of the load capacitance element is variable.

4. The apparatus according to claim 3, further comprising a clamp capacitance element connected to an input node to which the reference signal of the comparison circuit is supplied,
wherein the clamp capacitance element is configured to set not less than two capacitance values.

5. The apparatus according to claim 1, wherein the selector determines a signal level of the pixel signal and selects a reference signal line, of the plurality of reference signal lines, to which a reference signal used for A/D conversion is supplied.

6. The apparatus according to claim 1, wherein a plurality of buffers including the buffer and the other buffer are provided,
each of the plurality of reference signal lines is connected to an input node of a corresponding one of the plurality of buffers so as to make one reference signal line correspond to one buffer, and
the connector is configured to switch connection between an output node of each of the plurality of buffers and an input node of each of the comparison circuit and the load capacitance element.

7. The apparatus according to claim 1, wherein the output node of the buffer is connected to the input node of the comparison circuit,
the output node of the other buffer is connected to the output node of the load capacitance element, and
the connector is configured to switch connection between each of the plurality of reference signal lines and the input node of a corresponding one of the buffer and the other buffer.

8. The apparatus according to claim 1, wherein the load capacitance element is a grounded capacitance element.

9. An equipment comprising:
the photoelectric conversion apparatus according to claim 1; and
a processor configured to process a signal output from the photoelectric conversion apparatus.
